(19) United States
(12) Patent Application Publication
(10) Pub. No.: US 2013/0244111 A1
(43) Pub. Date: Sep. 19, 2013

(54) POSITIVE ACTIVE MATERIAL, METHOD OF PREPARING THE SAME, AND LITHIUM SECONDARY BATTERY USING THE SAME

(71) Applicant: SAMSUNG CORNING PRECISION MATERIALS CO., LTD., Gumi (KR)

(72) Inventors: Hae In CHO, Asan (KR); Jae Ha Shim, Asan (KR); Hyung Cheoul Shim, Asan (KR); Dong Myung Yoon, Asan (KR); Sung Nim Jo, Asan (KR)

(73) Assignee: SAMSUNG CORNING PRECISION MATERIALS CO., LTD., Gumi (KR)

(21) Appl. No.: 13/739,305

(22) Filed: Jan. 11, 2013

(30) Foreign Application Priority Data
Mar. 13, 2012 (KR) 10-2012-0025740

(51) Int. Cl. H01M 4/131

(52) U.S. Cl. CPC H01M 4/131
USPC 429/219; 429/224; 429/223; 429/221; 252/182.1

(57) ABSTRACT

Provided are a positive active material including a spinel lithium manganese oxide surface-coated with one or more types of nanoparticles selected from olivine-type lithium metal phosphate and metal oxide, a method of preparing the same and a lithium secondary battery using the same. The positive active material provides a lithium secondary battery having improved high-temperature cycle life characteristic and capacity per weight.

### CROSS-REFERENCE TO RELATED APPLICATION

This application claims priority to and the benefit of Korean Patent Application No. 10-2012-0025740, filed on Mar. 13, 2012, the entire content of which is incorporated herein by reference.

### BACKGROUND OF THE INVENTION

1. Field of the Invention

Aspects of the present invention relate to a positive active material including a spinel lithium metal oxide, a method of preparing the same and a lithium secondary battery using the same.

2. Description of the Related Art

As applications of lithium secondary batteries are gradually extending from power sources for small-sized electric/electronic devices to power sources and power storage for large-sized electric/electronic devices such as electric vehicles, there is an increasing demand for a positive active material for a secondary battery having improved properties including high safety, long cycle life, high energy density and high power capability.

Lithium cobalt oxides, lithium manganese oxides, lithium composite oxides may be used as the positive active material. Specifically, spinel lithium manganese oxides are less costly than other materials and are environmentally friendly and highly safe because they do not include heavy metals, such as cobalt. Owing to the advantages, the spinel lithium manganese oxides are extending their applications to power supply sources and power storage for environmentally friendly electric vehicles or hybrid electric vehicles.

However, using the spinel lithium manganese oxide as the positive active material is considered problematic because when the battery is used under a high temperature condition for a long time, the lifetime of battery is rapidly reduced due to electrolyte decomposition by elution of manganese ions at high temperature and the remaining capacity of battery is sharply reduced.

Accordingly, there is a need for a positive active material for improving high-rate and cycle life characteristics of a spinel lithium manganese oxide.

### BRIEF SUMMARY OF THE INVENTION

Aspects of the present invention provide a positive active material having a stable cycle characteristic at high temperature without a reduction in capacity per weight and high-rate characteristic, a method of preparing the same and a lithium secondary battery using the same.

In accordance with one aspect of the present invention, there is provided a positive active material including a spinel lithium manganese oxide surface-coated with one or more types of nanoparticles selected from olivine-type lithium metal phosphate and metal oxide.

The spinel lithium manganese oxide may be represented by Formula (1):

LiMₓMn₂₋ₓO₄ (1)

wherein M is at least one selected from the group consisting of Ni, Zr, Co, Mg, Mo, Al, Ti, Cr, Gd and Ag, and 0≦x<1.

The olivine-type lithium metal phosphate may be represented by Formula (3):

LiM₍₁₋ₓ₎AₓPO₄ (3)

wherein M and A are different from each other, M is at least one of Fe and Mn, A is at least one selected from the group consisting of Mn, Ni, Zr, Co, Mg, Mo, Al, Ag, Y and Nb, and 0≦x<1.

The metal oxide may be an oxide including at least one selected from the group consisting of Fe, Mg, Ca, Zn, Sn, Sr, Pb, Cd, Ba, Be, Zr and Al.

The nanoparticles may have a particle diameter of 100 nm or less.

In accordance with another aspect of the present invention, there is provided a method of preparing a positive active material, the method including preparing a spinel lithium manganese oxide represented by Formula (1) by mixing a lithium compound and a compound including at least one of M and manganese and performing heat treatment on the resultant mixture, and surface-coating the spinel lithium manganese oxide by forming a coating layer by mixing the spinel lithium manganese oxide with one or more types of nanoparticles selected from olivine-type lithium metal phosphate and metal oxide.

As described above, according to the present invention, stable surface coating can be achieved by employing a nanosized olivine-type lithium metal phosphate and a metal oxide to a spinel lithium manganese oxide, a side reaction between a composite oxide and an electrolyte solution at high temperature can be prevented by forming the coating layer, thereby providing a lithium secondary battery having improved high-temperature cycle life characteristic and capacity per weight.

Additional aspects and/or advantages of the invention will be set forth in part in the description which follows and, in part, will be obvious from the description, or may be learned by practice of the invention.

### BRIEF DESCRIPTION OF THE DRAWINGS

The objects, features and advantages of the present invention will be more apparent from the following detailed description in conjunction with the accompanying drawings, in which:

FIG. 1 is a scanning electronic microscope (SEM) view showing a surface-coated spinel lithium manganese oxide according to Example 1;

FIG. 2 is a scanning electronic microscope (SEM) view showing a surface-coated spinel lithium manganese oxide according to Example 2;

FIG. 3 is a scanning electronic microscope (SEM) view showing a surface-coated spinel lithium manganese oxide according to Comparative Example 1;

FIG. 4 is a graph illustrating the cycle capacity of secondary batteries including surface-coated spinel lithium manganese oxides according to Examples 1 and 2;

FIG. 5 is a graph illustrating the cycle capacity of secondary batteries including surface-coated spinel lithium manganese oxides according to Example 3 and Comparative Example 1; and

FIG. 6 illustrates cycle capacity retention of secondary batteries including surface-coated spinel lithium manganese oxides according to Examples 1 and 2 and Comparative Example 1.

### DETAILED DESCRIPTION OF THE INVENTION

Hereinafter, embodiments of the present invention will be described in detail with reference to the accompanying drawings.

The present invention provides a positive active material including a spinel lithium manganese oxide surface-coated with one or more types of nanoparticles selected from olivine-type lithium metal phosphate and metal oxide. The present invention also provides an electrode or battery having a stable cycle characteristic at high temperature without a reduction in high-rate characteristic and capacity per weight by employing the surface-coated spinel lithium manganese oxide as a positive active material.

The spinel lithium manganese oxide is represented by Formula (1), and is further substituted with fluorine as represented by Formula (2):

LiMₓMn₂₋ₓO₄ (1)

wherein M is at least one selected from the group consisting of Ni, Zr, Co, Mg, Mo, Al, Ti, Cr, Gd and Ag, and 0≦x<1; and

LiMₓMn₂₋ₓO₄—_{z}F_{z} (2)

wherein M is at least one selected from the group consisting of Ni, Zr, Co, Mg, Mo, Al, Ti, Cr, Gd and Ag, 0≦x<1, and 0≦z<1. The spinel lithium manganese oxide is preferably a spinel lithium nickel manganese oxide.

The olivine-type lithium metal phosphate and the metal oxide, forming the coating layer of the spinel lithium manganese oxide, are nanoparticles, so that a structurally stable coating layer. In addition, the coating layer exhibits high thermal stability, thereby improving high-temperature cycle life characteristic and capacity per weight of electrode or battery by preventing elution of manganese ions due to a reaction between an electrolyte and spinel lithium manganese oxide during charging and discharging at high temperature and preventing a decomposition reaction of an organic electrolyte due to the elution of manganese ions.

The olivine-type lithium metal phosphate may be represented by Formula (3):

LiM₍₁₋ₓ₎AₓPO₄ (3)

wherein M and A are different from each other, M is at least one of Fe and Mn, A is at least one selected from the group consisting of Mn, Ni, Zr, Co, Mg, Mo, Al, Ag, Y and Nb, and 0≦x<1.

In view of structural stability and high-temperature characteristic, the olivine-type lithium metal phosphate is preferably LiFePO₄, LiMnPO₄ or LiFe₍₁₋ₓ₎MnₓPO₄.

The metal oxide is at least one oxide selected from the group consisting of Fe, Mg, Ca, Zn, Sn, Sr, Zr, Pb, Cd, Ba, Be, Zr and Al, and is preferably ZnO or SnO₂.

The olivine-type lithium metal phosphate and the metal oxide are nanoparticles having a particle diameter of 100 nm or less, preferably 1 to 100 nm, more preferably 1 to 70 nm.

The present invention also provides a method of preparing the positive active material. The method includes preparing a spinel lithium manganese oxide and surface-coating the spinel lithium manganese oxide.

The preparing of the spinel lithium manganese oxide comprises preparing the spinel lithium manganese oxide by mixing a lithium compound as a precursor compound represented by Formula (1) or (2) and a compound including at least one of M and manganese and performing heat treatment on the resultant mixture.

The heat treatment may be performed in an air or inert gas atmosphere at a temperature ranging from 700 to 1000° C., preferably from 800 to 950° C., for 5 to 24 hours. After the performing of the heat treatment, grinding or pulverizing may further be performed to control particle sizes of the spinel lithium manganese oxide while removing impurities.

Examples of the lithium compound include at least one selected from the group consisting of lithium-containing hydroxide, ammonium, sulfate, alkoxide, oxalate, phosphate, halide, oxyhalide, sulfide, oxide, peroxide, acetate, nitrate, carbonate, citrate, phthalate, perchlorate, acetylacetonate, acrylate, formate, oxalate and hydrides thereof.

Examples of the compound including at least one of M and manganese include at least one selected from the group consisting of hydroxide, ammonium, sulfate, alkoxide, oxalate, phosphate, halide, oxyhalide, sulfide, oxide, peroxide, acetate, nitrate, carbonate, citrate, phthalate, perchlorate, acetylacetonate, acrylate, formate, oxalate and halide compounds and hydrides thereof.

Particle diameters of the prepared spinel lithium manganese oxide are 20 μm or less, preferably in a range of 5 to 20 μm.

The surface-coating of the spinel lithium manganese oxide includes forming a coating layer on the surface of the spinel lithium manganese oxide by mixing the spinel lithium manganese oxide with one or more types of the nanoparticles selected from olivine-type lithium metal phosphate and metal oxide.

The surface-coating includes dry-type mixing for 5 to 60 minutes using a ball mill or a dry-type mixer.

In the surface-coating, the one or more types of nanoparticles selected from olivine-type lithium metal phosphate and metal oxide and the spinel lithium manganese oxide are mixed in a ratio ranging from 1:100 to 1:25 by mass and then coated on the spinel lithium manganese oxide. When the mixing ratio is in the range stated above, a stable coating layer can be provided and the high-temperature cycle life characteristic and capacity per weight of battery can be improved.

The present invention also provides a lithium secondary battery including the positive active material.

The lithium secondary battery may include a positive electrode including a positive active material, a negative electrode, a separator and a nonaqueous electrolyte solution. Manufacturing methods of the lithium secondary battery are well known in the art to which the present invention pertains, and any method can be appropriately selected unless it deviates from the spirit, and scope of the invention.

For example, the positive electrode is prepared by coating a positive active material composition including the positive active material according to the present invention and a binder on a positive electrode current collector, drying and pressing.

The binder may bind the positive active materials and fix the same to the current collector. Any binder that is used in the art to which the present invention pertains can be used without limitation. Preferably, the binder may be at least one selected from the group consisting of polyvinylidenefluoride, polytetrafluoroethylene, polyvinylchloride, polyvinylpyrrolidone, polyvinyl alcohol, carboxyl methyl cellulose (CMC), starch, hydroxypropylcellulose, polyethylene, polypropylene styrene butadiene rubber (SBR) and fluorine rubber.

The positive active material composition may include a positive active material and a binder, optionally including a solvent such as NMP(N-Methyl-2-pyrrolidone) and olefin polymers such as polyethylene or polypropylene, and further including a filler made of a fibrous material such as glass fiber or carbon fiber. The positive active material composition may further include a conductive agent listed below in describing the negative electrode.

Examples of the positive electrode current collector may include copper, stainless steel, aluminum, nickel, titanium, sintered carbon copper or stainless steel that is surface-treated with carbon, nickel, titanium, or silver; and aluminum-cadmium alloy and may be formed in various types, including a film, a sheet, a foil, a net, a porous body, a foamed body, a non-woven fabric body, and so on.

The negative electrode may be prepared by coating a negative active material composition including a negative active material on a negative electrode current collector, drying and pressing. The negative electrode may be formed by a lithium metal. Optionally, the negative active material composition may further include a binder and a conductive agent.

The negative active material may include artificial graphite, natural graphite, graphitized carbon fiber, a carbon-based material such as amorphous carbon, lithium, alloys between lithium and silicon (Si), Al, tin (Sn), lead (Pb), Zn, bismuth (Bi), indium (In), Mg, gallium (Ga), or cadmium (Cd), an alloyable metallic compound such as Sn alloy and Al alloy, and a composite material including the metallic compound and carbon-based material.

Examples of the negative electrode current collector may include copper, stainless steel, aluminum, nickel, titanium, sintered carbon; copper or stainless steel that is surface-treated with carbon, nickel, titanium, or silver; and aluminum-cadmium alloy and may be formed in various types, including a film, a sheet, a foil, a net, a porous body, a foamed body, a non-woven fabric body, and so on.

The separator is disposed between the negative electrode and the positive electrode, and may be formed using an olefin-based polymer such as polypropylene; and a sheet or non-woven fabric made of glass fiber or polyethylene. Examples of the separator may include polyethylene, polypropylene, polytetrafluoroethylene (PTFE), a multi-layered structure having two or more layers of these materials, a composite multi-layered structure such as a polyethylene/polypropylene two layered separator, a polyethylene/polypropylene/polyethylene three layered separator, or a polypropylene/polyethylene/polypropylene three layered separator.

The nonaqueous electrolyte solution may be prepared by dissolving a lithium salt in the nonaqueous electrolyte. Examples of the lithium salt may include LiCl, LiBr, LiI, LiClO₄, LiBF₄, LiB₁₀OCl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, and chloroborane lithium.

The nonaqueous electrolyte solution may include a nonaqueous organic solvent, an organic solid electrolyte, an inorganic solid electrolyte, and so on. Examples of the nonaqueous electrolyte solution may include ethylene carbonate, propylene carbonate, butylene carbonate, vinylene carbonate, dimethyl carbonate, methylethyl carbonate, diethyl carbonate, methyl acetate, ethyl acetate, proply acetate, methyl propionate, ethyl propionate, γ-butyrolactone, 1,2-dimethoxyethane, 1,2-diethoxyethane, tetrahydrofuran, 1,2-dioxane, 2-methyltetrahydrofuran, acetonitrile, dimethylformamide, N-methyl-2-pyrrolidinone, dimethylsulfoxide, 1,3-dimethyl-2-imidazolidinone, sulforane, methyl sulforane and so on.

The organic solid electrolyte may be a gel-phase polymer electrolyte including an electrolyte solution impregnated in a polymer electrolyte such as polyethylene oxide or polyacrylonitrile.

The inorganic solid electrolyte may be nitrides, halides, or sulfates of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂ and so on.

The lithium secondary battery may be classified into a coin type, a prismatic type, a cylindrical type, and a pouch type. Configurations and manufacturing methods of the respective types of batteries are well known in the art and a detailed description thereof will be omitted.

The embodiments are described in more detail with reference to Examples and Comparative Examples below. The Examples and Comparative Examples are for illustrative purposes only and are not intended to limit the scope of the invention.

### PREPARATION EXAMPLE 1

### Preparation of Spinel LiNi_{0.5}Mn_{1.5}O₄

Lithium carbonate (Li₂CO₃) and nickel manganese hydroxide (Ni_{0.25}Mn_{0.75}) were homogenized in a 1:2 chemical equivalent ratio of Li with other metal, and heated under an air atmosphere at a temperature of 850° C. for 24 hours to complete the preparation of having a particle diameter of approximately 12 μm (Grainness D50) spinel LiNi_{0.5}Mn_{1.5}O₄positive active material.

### EXAMPLE 1

100 g of the LiNi_{0.5}Mn_{1.5}O₄prepared in Preparation Example 1 as a positive active material and 2 g of ZnO having a particle diameter of 100 nm or less were mixed using a dry-type powder mixer for 10 minutes and coated on a surface of the LiNi_{0.5}Mn_{1.5}O₄ active material, giving a composite active material. The composite active material, Denka Black as a conductive agent and PVDF as a binder were mixed in a ratio of 94:3:3 (mass ratio) and coated on an Al foil to manufacture an electrode plate. A thin Li ion conductive layer prepared by mixing a PEO polymer and LiClO₄ was coated on the manufactured electrode plate, followed by drying. A thickness of the coated Li ion conductive layer was controlled to be 1 μm or less. A coin-type cell was manufactured using Li metal as a negative electrode, and a mixture solution of ethylene carbonate (EC), in which 1.3M of LiPF6 is dissolved, dimethylene carbonate (DMC) and ethylene carbonate (EC) (mass ratio of 5:3:2) as an electrolyte.

### EXAMPLE 2

A composite active material and a coin cell were manufactured in the same manner as in Example 1, except that 100 g of LiNi_{0.5}Mn_{1.5}O₄prepared in Preparation Example 1 as a positive active material and 2 g of SnO₂ having a particle diameter of 100 nm or less were used.

### EXAMPLE 3

A composite active material was manufactured in the same manner as in Example 1, except that 100 g of LiNi_{0.5}Mn_{1.5}O₄prepared in Preparation Example 1 as a positive active material and 2 g of LiFePO₄ having a particle diameter of 100 nm or less were used.

The composite active material, Denka Black as a conductive agent and PVDF as a binder were mixed in a ratio of 94:3:3 (mass ratio) and coated on an Al foil to manufacture an electrode plate. A coin-type cell was manufactured using Li metal as a negative electrode, and a mixture solution of ethylene carbonate (EC), in which 1.3M of LiPF6 is dissolved, dimethylene carbonate (DMC) and ethylene carbonate (EC) (mass ratio of 5:3:2) as an electrolyte.

### EXAMPLE 4

A composite active material and a coin cell were manufactured in the same manner as in Example 1, except that 100 g of LiNi_{0.5}Mn_{1.5}O₄prepared in Preparation Example 1 as a positive active material and 2 g of LiMnPO₄ having a particle diameter of 100 nm or less were used.

### EXAMPLE 5

A composite active material and a coin cell were manufactured in the same manner as in Example 1, except that 100 g of LiNi_{0.5}Mn_{1.5}O₄prepared in Preparation Example 1 positive active material and 2 g of LiFe_{0.6}Mn_{0.4}PO₄ having a particle diameter of 100 nm or less were used.

### COMPARATIVE EXAMPLE 1

LiNi_{0.5}Mn_{1.5}O₄prepared in Preparation Example 1 as a positive active material, Denka Black as a conductive agent and PVDF as a binder were mixed in a ratio of 94:3:3 (mass ratio) and coated on an Al foil to manufacture an electrode plate. A coin-type cell was manufactured using the manufactured electrode plate as a positive electrode, Li metal as a negative electrode, and a mixture solution of ethylene carbonate (EC), in which 1.3M of LiPF6 is dissolved, dimethylene carbonate (DMC) and ethylene carbonate (EC) (mass ratio of 5:3:2) as an electrolyte.

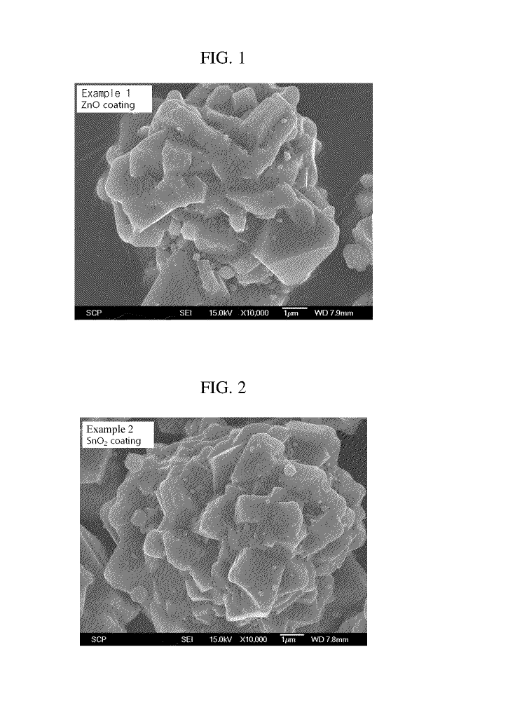

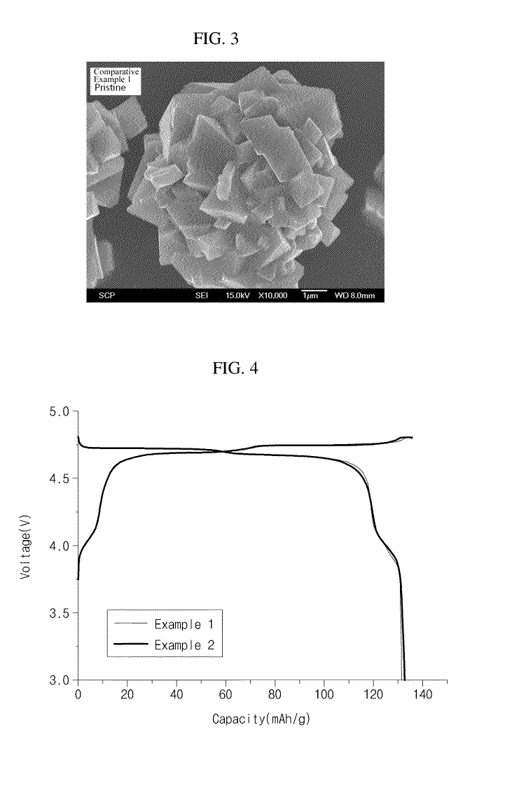

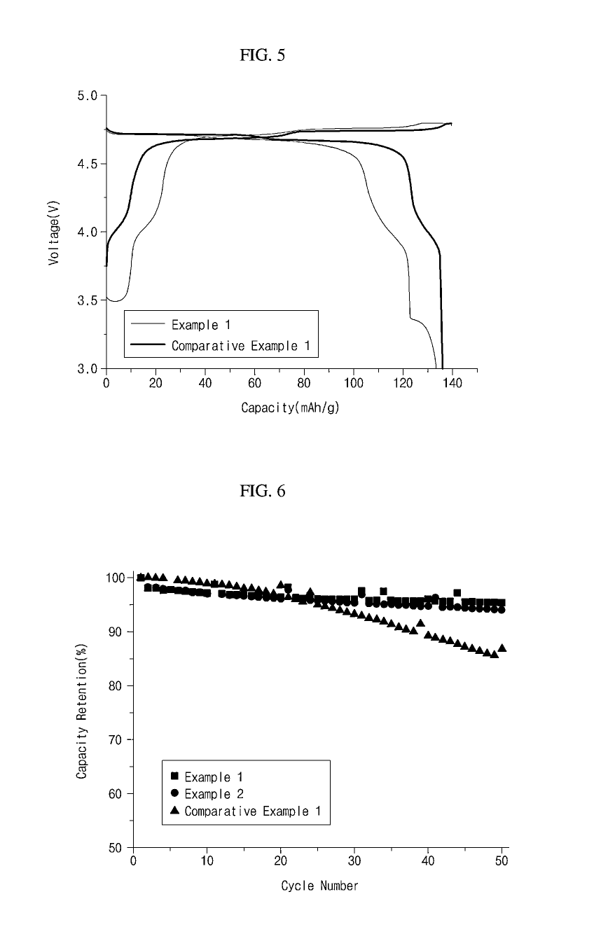

The cycle battery capacity and high-temperature (at 55° C.) capacity retention of each of coin cells manufactured in Examples and Comparative Example were measured and the results thereof are shown in Table 1 and FIGS. 4 to 6. In addition, SEM views of composite active materials prepared in Examples were observed. As confirmed from the SEM views, coating layers were formed on the surface of LiNi_{0.5}Mn_{1.5}O₄positive active material (Refer to FIGS. 1 to 3.).

TABLE 1

| | | | Capacity |
|---|---|---|---|
| | | Battery capacity | retention ratio (%) |
| | Coating material | (mAh/g) | @ 50 cycles, 55° C. |
| Example 1 | ZnO | 132 | 95% |
| Example 2 | SnO₂ | 133 | 94% |
| Example 3 | LiFePO₄ | 133 | 92% |
| Example 4 | LiMnPO₄ | 133 | 92% |
| Example 5 | LiFe_{0.6}Mn_{0.4}PO4 | 133 | 94% |
| Comparative | Pristine | 135 | 85% |
| Example 1 | | | |

In Table 1, high-temperature retention ratio is a discharge capacity retention ratio (%) measured when coin cells were charged and discharged for 50 cycles at a 1 C rate at 55° C.

As shown in Table 1, the composite active materials prepared in Examples 1 to 5 are prepared by forming a coating layer of olivine-type lithium metal phosphate and metal oxide on LiNi_{0.5}Mn_{1.5}O₄ positive active material. The prepared composite active materials turned out to have high battery capacity and demonstrated a large increase in the high-temperature retention ratio compared to the active material without a coating layer prepared in Comparative Example 1.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A positive active material comprising a spinel lithium manganese oxide surface-coated with one or more types of nanoparticles selected from olivine-type lithium metal phosphate and metal oxide.

2. The positive active material of claim 1, wherein the spinel lithium manganese oxide is represented by Formula (1):
LiMₓMn₂₋ₓO₄ (1)
wherein M is at least one selected from the group consisting of Ni, Zr, Co, Mg, Mo, Al, Ti, Cr, Gd and Ag, and 0≦x<1.

3. The positive active material of claim 1, wherein the spinel lithium manganese oxide is represented by Formula (2):
LiMₓMn₂₋ₓO₄—_{z}F_{z} (2)
wherein M is at least one selected from the group consisting of Ni, Zr, Co, Mg, Mo, Al, Ti, Cr, Gd and Ag, 0≦x<1, and 0<z<1.

4. The positive active material of claim 1, wherein the olivine-type lithium metal phosphate is represented by Formula (3):
LiM'₍₁₋ₓ₎AₓPO₄ (3)
wherein M′ and A are different from each other, M′ is at least one of Fe and Mn, A is at least one selected from the group consisting of Mn, Ni, Zr, Co, Mg, Mo, Al, Ag, Y and Nb, and 0≦x<1.

5. The positive active material of claim 1, wherein the metal oxide is an oxide including at least one selected from the group consisting of Fe, Mg, Ca, Zn, Sn, Sr, Pb, Cd, Ba, Be, Zr and Al.

6. The positive active material of claim 1, wherein the nanoparticles have a particle diameter of 100 nm or less.

7. A method of preparing a positive active material, the method comprising:
surface-coating a spinel lithium manganese oxide by forming a coating layer by mixing the spinel lithium manganese oxide with one or more types of nanoparticles selected from olivine-type lithium metal phosphate and metal oxide.

8. The method of claim 7, wherein the spinel lithium manganese oxide is represented by Formula (1):
LiMₓMn₂₋ₓO₄ (1)
wherein M is at least one selected from the group consisting of Ni, Zr, Co, Mg, Mo, Al, Ti, Cr, Gd and Ag, and 0≦x<1.

9. The method of claim 7, wherein the spinel lithium manganese oxide is represented by Formula (2):
LiMₓMn₂₋ₓO₄—_{z}F_{z} (2)
wherein M is at least one selected from the group consisting of Ni, Zr, Co, Mg, Mo, Al, Ti, Cr, Gd and Ag, 0≦x<1, and 0<z<1.

10. The method of claim 7, wherein the olivine-type lithium metal phosphate is represented by Formula (3):
LiM'₍₁₋ₓ₎AₓPO₄ (3)
wherein M′ and A are different from each other, M′ is at least one of Fe and Mn, A is one or more selected from the group consisting of Mn, Ni, Zr, Co, Mg, Mo, Al, Ag, Y and Nb, and 0≦x<1.

11. The method of claim 7, wherein the metal oxide is an oxide including at least one selected from the group consisting of Fe, Mg, Ca, Zn, Sn, Sr, Pb, Cd, Ba, Be, Zr and Al.

12. The method of claim 7, wherein a mixing ratio of the nanoparticles to the spinel lithium manganese oxide ranges from 1:100 to 1:25 by mass.

13. A lithium secondary battery comprising the positive active material of claim 1.
